(19) United States
(12) Patent Application Publication
(10) Pub. No.: US 2023/0225923 A1
(43) Pub. Date: Jul. 20, 2023

(54) APPARATUS FOR GIVING AUTOMATED MANIPULATION OF SOFT TISSUE PARTS OF A PERSON'S BODY

(71) Applicant: THE BARNES CLINIC LIMITED, Kent (GB)

(72) Inventors: Vincent James BARNES, Kent (GB); Robin COLES, Kent (GB); Martin WOLLACOTT, Worcestershire (GB)

(73) Assignee: THE BARNES CLINIC LIMITED, Kent (BR)

(21) Appl. No.: 18/002,475

(22) PCT Filed: May 21, 2021
(86) PCT No.: PCT/GB2021/000057

§ 371 Date: Dec. 19, 2022

(30) Foreign Application Priority Data
Jun. 17, 2020 (GB) 2009276.3

(51) Int. Cl. A61H 1/00

(52) U.S. Cl. CPC A61H 1/006; A61H 2201/1207

(57) ABSTRACT

An apparatus for giving automated manipulation of soft tissue parts of a person's body. The apparatus includes at least one manipulating device for manipulating the soft tissue parts, and at least one frame on which the manipulating device is mounted. The frame is configured such that the manipulation device is movable in use along the person's body when the person is lying on a treatment table. The manipulation device comprises a plurality of pistons for performing the manipulation of the soft tissue parts.

This invention relates to apparatus for giving automated manipulation of soft tissue parts of a person's body.

It is well known that the manipulation of soft tissue parts of a person's body may result in an improvement in a variety of muscular and/or joint conditions. The manipulation is typically carried out by a skilled practitioner. The manipulation typically involves repeated flexing or massaging movements which produce the improvement. The manipulation by the practitioner requires considerable physical effort from the practitioner. This may lead to the practitioner becoming tired and possibly lead to early degenerative changes. This is especially so if the part of the person's body being treated has a chronic condition such that fibrosis of the tissues has occurred. In this case, the manipulation may need to be carried out over a relatively long treatment period of, for example, 30-45 minutes. If the practitioner becomes tired, then it is difficult for the practitioner to maintain an even treatment, especially if the practitioner needs to apply substantial force to the soft tissue parts being manipulated.

Apparatus is known which gives automatic manipulation of soft tissue parts of a person's body. The known apparatus is thus able to overcome the problem of the practitioner becoming tired. One such type of apparatus for giving the automated manipulation is disclosed in U.S. Pat. No. 6,267,737 B1. Another type of known apparatus for giving the automated manipulation is disclosed in WO 2015/004484 A2.

It is an aim of the present invention to provide an improved apparatus for giving automated manipulation of soft tissue parts of a person's body.

Accordingly, in one non-limiting embodiment of the present invention there is provided apparatus for giving automated manipulation of soft tissue parts of a person's body, which apparatus comprises:

(i) at least one manipulating device for manipulating the soft tissue parts; and

at least one frame on which the manipulating device is mounted, and wherein:

the frame is configured such that the manipulation device is movable in use along the person's body when the person is lying on a treatment table; and

(iv) the manipulation device comprises a plurality of pistons for performing the manipulation of the soft tissue parts.

The apparatus of the present invention is advantageous in that the manipulation device comprises the plurality of pistons for performing the manipulation of the soft tissue parts. The use of the plurality of pistons enables the manipulation to be performed around various contours as occurs with different types of soft tissue parts. The head of the manipulation device is thus able to operate in an optimal effective manner on all areas of the soft tissue parts. In addition, the head of the manipulation device is able to operate in a localised area defined by the size of the manipulation device, and thus the manipulation device is able to concentrate the force so that the force is applied solely to the area requiring the treatment.

The apparatus may be one in which the pistons are hydraulically operated pistons, pneumatically operated pistons, or electrically operated pistons. Alternatively, the pistons may be sprung loaded pistons.

The apparatus may include control means for controlling the operation of the manipulating device. The control means may thus control, for example, the pressure which is exerted by the pistons on the soft tissue parts.

The control means may be configured to control all the pistons together, whereby all the pistons exert substantially the same pressure on the soft tissue parts.

The apparatus may include mounting means for mounting the manipulating device with respect to the frame such that the manipulating device is able to follow contours of the soft tissue parts requiring the manipulation.

The mounting means may be a pivot mounting means. Other types of mounting means may be employed. When the mounting means is a pivot mounting means, then the pivot mounting means preferably comprises a lockable ball joint. The lockable ball joint enables lateral tilt as well as forwards and backwards tilt so that the ball joint can accurately position the head of the manipulating device to the contour of the soft tissue before being locked into position.

The apparatus may be one in which there are two of the manipulating devices, with each manipulating device producing the same pressure. Alternatively, if desired, there may be one of the manipulating devices, or more than two of the manipulating devices, again with each manipulating device producing the same pressure.

The apparatus may include connector means for connecting the frame to the treatment table. The connector means may comprise a support rail, for example for supporting pieces of equipment. Other types of connector means may be employed.

The apparatus may be one in which there are two of the frames. Where there are two of the frames, then one of the frames may be employed along each side of the treatment table. Alternatively, the apparatus may be one in which there is only one of the frames, in which case the frame will normally be employed along one side of the treatment table. The or each frame may be of any suitable and required construction. Typically the or each frame may be mounted on wheels in order to facilitate manoeuvrability of the frame or frames, for example as may be required for enabling a patient to access and leave the treatment table and/or for cleaning purposes.

Where there are two of the frames, then the apparatus may include securing means for securing the two frames together. The use of the securing means may be advantageous in that it may secure the two frames together and thereby act to counteract any unwanted movement of the frames during the treatment of the person on the treatment table.

The apparatus may be one which includes learning means for enabling the apparatus firstly to learn manual manipulating movements of a practitioner manually manipulating the soft tissue parts of the person's body, and in which the apparatus is configured then to operate in an automated mode but with the learnt manual manipulating movements. The learning means may comprise a learning arm.

The apparatus may include a first recording facility for recording the manual manipulating movements, and control means for enabling the apparatus to operate in the automated mode but with the learnt manual manipulating movements.

The apparatus may include a second recording facility for recording details of the person for use when the same person is being treated on a subsequent occasion. The first and second recording facilities may be made available via a single memory means.

The apparatus may include a first stop facility for stopping operation of the apparatus on a temporary basis for allowing examination of the person by a practitioner during a treatment session.

The apparatus may include a second stop facility for enabling a person to stop the apparatus. Thus, for example, the second stop facility may enable a person to stop the apparatus if the person feels uncomfortable during a treatment session.

The apparatus of the present invention may include the treatment table. If desired, the apparatus of the present invention may be manufactured and sold without the treatment table.

Embodiments of the invention will now be described solely by way of example and with reference to the accompanying drawings in which:

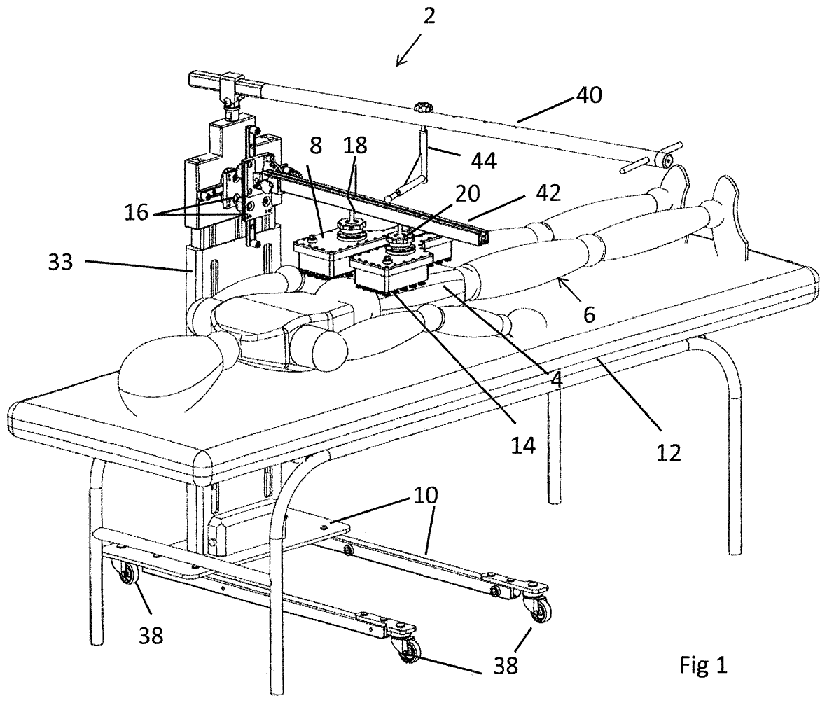

FIG. 1 is a perspective view from the front and one side of apparatus for giving automatic manipulation of soft tissue parts of a person's body;

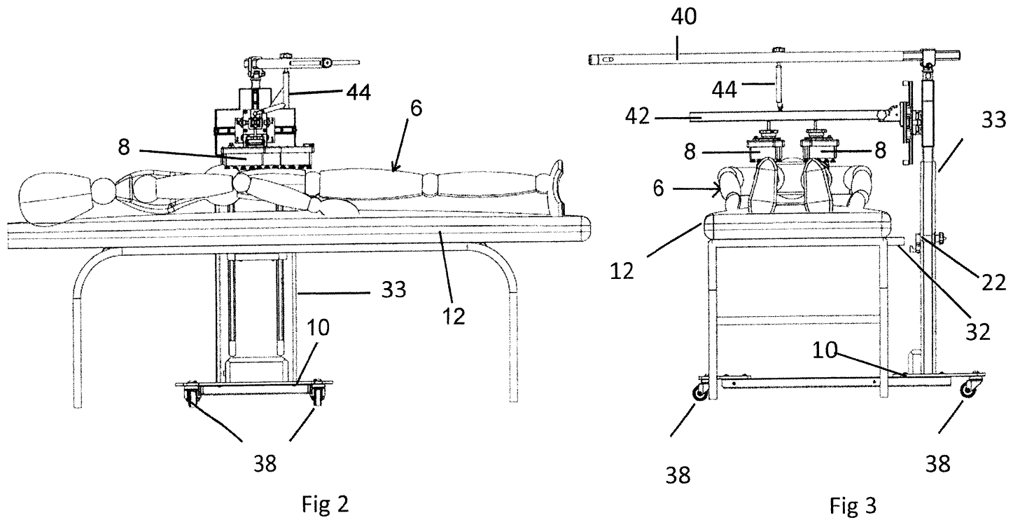

FIG. 2 is side view of the apparatus as shown in FIG. 1;

FIG. 3 is an end view of the apparatus as shown in FIG. 1;

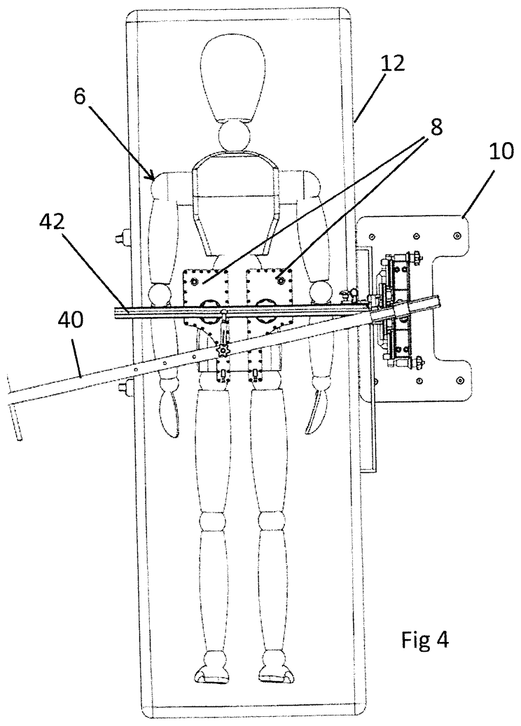

FIG. 4 is a top view of the apparatus as shown in FIG. 1;

FIG. 5 is a top view of part of a manipulating device used in the apparatus shown in FIG. 1;

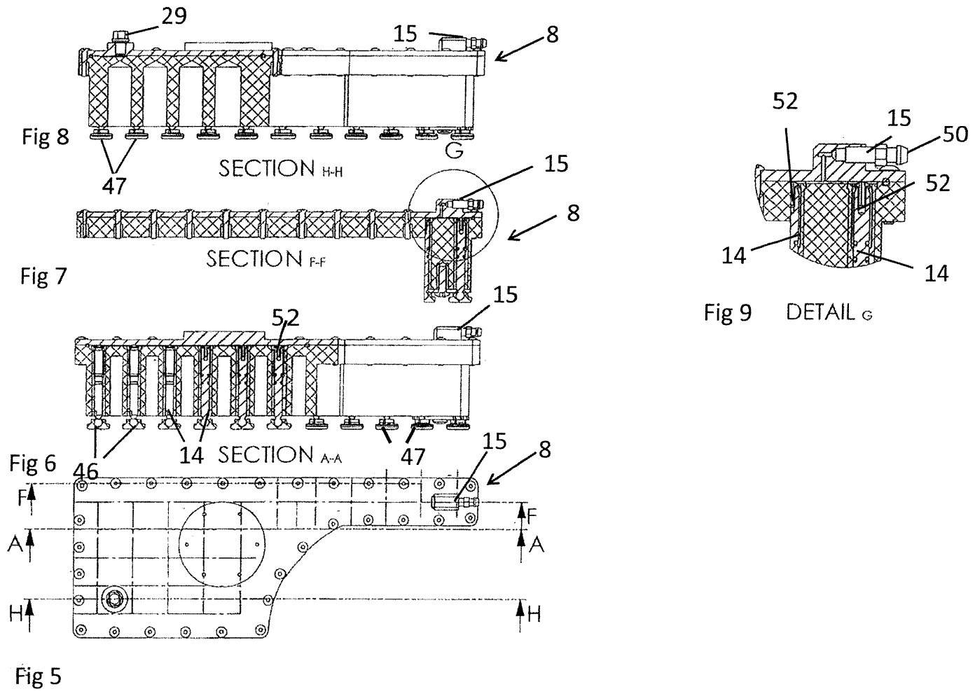

FIG. 6 is a section on the line A-A shown in FIG. 5;

FIG. 7 is a section on the line F-F shown in FIG. 5;

FIG. 8 is a section on the line H-H shown in FIG. 5;

FIG. 9 is an enlarged detail of the circled part shown in FIG. 7;

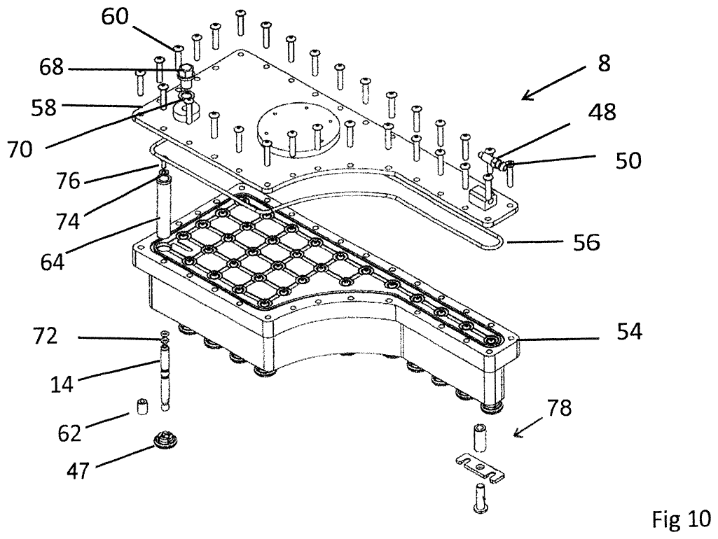

FIG. 10 is an exploded perspective view of the part shown in FIGS. 5-9;

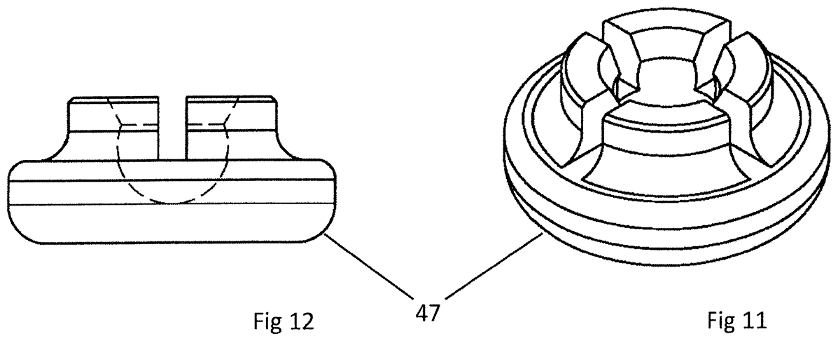

FIG. 11 is a view from above and one side of a foot used in the apparatus; and

FIG. 12 is a side view of the foot shown in FIG. 11.

Referring to the drawings, there is shown apparatus 2 for giving automated manipulation of soft tissue parts 4 of a person's body 6. The apparatus 2 comprises at least one manipulating device 8 for manipulating the soft tissue parts 4. The apparatus 2 also comprises at least one frame 10 on which the manipulating device 8 is mounted.

The frame 10 is configured such that the manipulating device 8 is movable in use along the person's body 6 when the person is lying on a treatment table 12. The manipulation device 8 comprises a plurality of pistons 14 for performing the manipulation of the soft tissue parts 4.

The pistons 14 are hydraulically operated pistons 14. The hydraulic fluid for the pistons 14 is in a closed system whereby each of the piston heads is filled with hydraulic fluid at a filler port, and is pressurised with hydraulic oil via a nipple 15. The hydraulic oil is provided along appropriate conduits (not shown) and via a supply pump (not shown). In alternative embodiments of the invention, the pistons 14 may be pneumatically operated pistons, electrically operated pistons, or sprung loaded pistons.

The apparatus 2 comprises control means 16 for controlling operation of the manipulating device 8. The control means 16 is configured to control all the pistons 14 together, whereby the pistons 14 are controlled to exert the same pressure on the soft tissue parts 4 of the person's body 6. The control means 16 may comprise X-Y carriages, a mounting holder, and an automated power source.

The apparatus 2 includes mounting means 18 for mounting the manipulating device 8 with respect to the frame 10 such that the manipulating device 8 is able to follow contours of the soft tissue parts 4 requiring the manipulation. The mounting means 18 comprises a mounting arm 42 that holds a pivot ball joint 20. The mounting arm 42 is a slotted aluminium extrusion 42. The mounting means 18 is thus connected to the X-Y carriage of the control means 16. The apparatus 2 is such that there are two of the manipulating devices 8.

The apparatus 2 includes connector means 22 for connecting the frame 10 to the treatment table 12. More specifically, the connector means 22 is clamped to a motorised up/down lifting column 33 which in turn clamps to a support rail 32 on the treatment table 12. The support rail 32 is for supporting various items of equipment.

FIGS. 1-4 show the apparatus 2 comprising one frame 10 and two manipulating devices 8, with the apparatus 2 being positioned along one longitudinal side of the treatment table 12. In an alternative embodiment of the invention, the apparatus 2 may comprise the two manipulating devices 8, and two frames 10. In this case, there will be one frame 10 positioned along each longitudinal side of the treatment table 12. The two frames 10 may be joined together to give the entire frame structure stability and to optimise on non-movement of the apparatus 2 during treatment sessions.

The apparatus 2 includes learning means for enabling the apparatus 2 to learn manual manipulating movements of a practitioner manually manipulating the soft tissue parts 4 of the person's body 6. The apparatus 2 is configured to operate in an automated mode but with the learnt manual manipulating movements.

The apparatus 2 includes a first recording facility for recording the manual manipulating movements, and control means for enabling the apparatus 2 to operate in the automated mode but with the learnt manual manipulating movements.

The apparatus 2 also includes a second recording facility for recording details of the person for use when the same person is being treated on a subsequent occasion. The first and second recording facilities may be in a single memory means (not shown).

The apparatus 2 includes a first stop facility for stopping operation of the apparatus 2 on a temporary basis for allowing examination of the person by a practitioner during a treatment session.

The apparatus 2 further includes a second stop facility for enabling a person to stop the apparatus themselves. Thus the person may stop the apparatus if the person should feel uncomfortable during an automated treatment session.

As shown in FIG. 1, the frame 10 is mounted on wheels 38. This enables the apparatus 2 easily to be manoeuvrable as may be required, for example for enabling persons being treated to climb onto and off the treatment table 12. FIG. 5 shows how the frame 10 comprises a learning arm 40 positioned above the mounting arm 42. The manipulating devices 8 are mounted on the mounting arm 42 via the pivot ball joint 20. The arms 40, 42 are connected together by connector means 44. Alternatively, the arms 40, 42 may be connected together by a tie bar with a ball joint which allows for lateral and forwards and backwards tilting.

FIGS. 5-10 illustrate the construction and working of the manipulating device 8. FIG. 5 shows the shape of the manipulating device 8. FIG. 6 shows the pistons 14. It will be noticed from FIG. 6 that the pistons 14 terminate in ball heads 46 and feet 47. The feet 47 are flat swivelling feet which push onto the ball heads 46 as can be appreciated from FIGS. 6, 7, 8, 11 and 12. The feet 47 may be made of nylon. Other materials for the feet 47 may be employed. In alternative embodiments of the invention, fixed ball or domed feet may be employed. The ball heads 46 and feet 47 enable the pistons 14 to massage the person's body 6 without causing discomfort to the person's body 6.

FIGS. 5-10 show the manipulating device 8 having the nipple 15. As best seen from FIG. 9, the nipple 15 has an end connector formation 50 for receiving a hydraulic pipe connected to a pump for the hydraulic fluid. The hydraulic fluid is preferably a food grade hydraulic fluid.

FIG. 9 also shows how the inner end of each piston 14 is provided with a screw 52.

FIG. 10 shows how the manipulating device 8 has a hydraulic head block 54, a gasket 56 and a top cap 58. The gasket 56 is sandwiched between the hydraulic head block 54 and the top cap 58. The top cap 58 is tightened in position by the illustrated thirty screws 60.

FIG. 10 also shows a threaded insert 62 and a piston bush 64. Also shown are the oil nipple 15, the end connector formation 50, an air release valve 68, a fibre washer 70, a screw 76, a washer 74 and an O-ring 72. The manipulating device 8 as shown in FIG. 10 has thirty two of the pistons 14, and thirty two of the O-rings with only one O-ring per piston being used. There are thirty of the fibre washers 70, and thirty screws. An optional clamp arrangement 78 is for holding down two of the pistons 14 if required.

The apparatus 2 is such that the frame 10 comprises an X-Y carriage mechanism which enables the manipulating devices 8 to be applied to the person's body 6 in an almost linear fashion or mild arc of movement. As indicated above, there may be two of the frames 10 locked together on opposite sides of the treatment table 12. The use of the two frames 10 helps to cancel out any turning movement on the table 10.

The apparatus 2 affords Y-motion of the automated section in order to allow for downwards movement onto the person on the treatment table 12. The X-motion of the automated section of the apparatus 2 allows for horizontal travel along the length of the person's body 6. The overall movement mimics the initial movement of a practitioner. This initial movement is able to be created by the practitioner using the illustrated arm 40 shown in FIG. 1 over a desired number of repetitions, for example twelve repetitions.

During use of the apparatus 2, the Y-motion and the X-motion may combine to enable the manipulating devices 8 to make the soft tissue parts 4 move by about 20-30 mm. The manipulating device 8 may operate on a pad (not shown) positioned between the pistons 14 and the person's body 6. The apparatus 2 may be used for any required treatment period, for example 45 minutes or 30 minutes. The treatment period depends upon the precise soft tissue parts for being treated so that, for example 45 minutes may be preferred for restorative treatment and 30 minutes may be preferred for neuro-muscular system stimulation. The apparatus 2 is such that the piston heads of the manipulating device 8 are able to match the contours of the soft tissue parts, due to the pivot ball joint 20 and also due to the holding arm 42 being fixed to the X-Y carriage on the frame 10.

It is to be appreciated that the embodiments of the invention described above with reference to the accompanying drawings have been given by way of example only and that modifications may be effected. Thus, for example, other shapes for the manipulating devices 8 and the frame 12 may be employed. Because the weight of the carriage, holding arm, learning arm and pistons is significant, a counter weight or spring may be employed to the end of the learning arm. The apparatus 2 may be sold with or without the treatment table 12. Individual components shown in the drawings are not limited to use in their drawings and they may be used in other drawings and in all aspects of the invention. The invention also extends to the individual components mentioned and/or shown above, taken singly or in any combination.

1. An apparatus for giving automated manipulation of soft tissue parts of a person's body, wherein the apparatus comprises:
at least one manipulating device for manipulating the soft tissue parts; and
at least one frame on which the manipulating device is mounted, and wherein
the frame is configured such that the manipulation device is movable in use along the person's body when the person is lying on a treatment table; and
the manipulation device comprises a plurality of pistons for performing the manipulation of the soft tissue parts.

2. The apparatus according to claim 1, in which the pistons are hydraulically operated pistons, pneumatically operated pistons, or electrically operated pistons.

3. The apparatus according to claim 1, in the pistons are sprung loaded pistons.

4. The apparatus according to claim 1, including control means for controlling the operation of the manipulating device.

5. The apparatus according to claim 4, in which the control means is configured to control all the pistons together, whereby all the pistons exert substantially the same pressure on the soft tissue parts.

6. The apparatus according to claim 1, including mounting means for mounting the manipulating device with respect to the frame such that the manipulating device is able to follow contours of the soft tissue parts requiring the manipulation.

7. The apparatus according to claim 6, in which the mounting means is a pivot mounting means.

8. The apparatus according to claim 7, in which the pivot mounting means comprises a ball joint.

9. The apparatus according to claim 1, in which there are two of the manipulating devices, with each manipulating device producing the same pressure.

10. The apparatus according to claim 1, including connector means for connecting the frame to the treatment table.

11. The apparatus according to claim 10, in which the connector means comprises a support rail.

12. The apparatus according to claim 1, in which there are two of the frames.

13. The apparatus according to claim 12, and including securing means for securing the two frames together.

14. The apparatus according to claim 1, including learning means for enabling the apparatus to learn manual manipulating movements of a practitioner manually manipulating the soft tissue parts of the person's body, and in which the apparatus is configured to operate in an automated mode but with the learnt manual manipulating movements.

15. The apparatus according to claim 14, and including a first recording facility for recording the manual manipulating movements, and control means for enabling the apparatus to operate in the automated mode but with the learnt manual manipulating movements.

16. The apparatus according to claim 1, including a second recording facility for recording details of the person for use when the person is being treated on a subsequent occasion.

17. The apparatus according to claim 1, including a first stop facility for stopping operation of the apparatus on a temporary basis for allowing examination of the person by a practitioner during a treatment session.

18. The apparatus according to claim 1, including a second stop facility for enabling a person to stop the apparatus.

19. The apparatus according to claim 1, including the treatment table.
